(19) United States
(12) Patent Application Publication
(10) Pub. No.: US 2006/0117523 A1
(43) Pub. Date: Jun. 8, 2006

(54) Paper weight and doorstop sports beanbag

(76) Inventor: Steven Davis, Fiskdale, MA (US)

Correspondence Address: LAW OFFICE OF MICHAEL A. BLAKE, 112 BROAD STREET, MILFORD, CT, 06460, US

(21) Appl. No.: 11/003,714

(22) Filed: Dec. 3, 2004

(51) Int. Cl. B60B 33/06

(52) U.S. Cl. 16/32

(57) ABSTRACT

The disclosed apparatus relates to a sports beanbag. The sports beanbag comprises: a beanbag exterior, wherein the beanbag exterior exhibits an image identifying a sports team; a first compartment located within the beanbag exterior, and configured to hold first amount of fill material; a second compartment located within the beanbag exterior and above the first compartment, and wherein the second compartment is configured to hold a second amount of fill material; and where first amount of fill material in the first compartment and the second amount of fill material in the second compartment are configured to generally maintain the beanbag in an upright position. The discloses apparatus also relates to a sports beanbag comprising: a beanbag exterior, wherein the beanbag exterior exhibits an image identifying a sports personality; a first compartment located within the beanbag exterior, and configured to hold first amount of fill material; a second compartment located within the beanbag exterior and above the first compartment, and wherein the second compartment is configured to hold a second amount of fill material; and where the first amount of fill material in the first compartment and the second amount of fill material in the second compartment are configured to generally maintain the beanbag in an upright position.

### TECHNICAL FIELD

This apparatus relates generally to paperweights and doorstops, and more particularly to device that provides a means displaying ones affinity for a sports team in a paperweight or a doorstop.

### BACKGROUND

Paperweights and doorstops are each known in the art. Paperweights may be as simple as a rock, or may be decorative such as a pliable bean bag representation of a dog or a cat. Doorstops may have a purely utilitarian design, such as a rubber wedge to fit under a door, or it may be a pliable bean bag representation of a dog or a cat.

However, there are no door stops or paperweights known in the art that are pliable, and allow a user to express his or her affinity or support for a particular sports team, sports program or sports figure.

### SUMMARY

The disclosed apparatus relates to a sports beanbag. The sports beanbag comprises: a beanbag exterior, wherein the beanbag exterior exhibits an image identifying a sports team; a first compartment located within the beanbag exterior, and configured to hold first amount of fill material; a second compartment located within the beanbag exterior and above the first compartment, and wherein the second compartment is configured to hold a second amount of fill material; and where first amount of fill material in the first compartment and the second amount of fill material in the second compartment are configured to generally maintain the beanbag in an upright position.

The discloses apparatus also relates to a sports beanbag comprising: a beanbag exterior, wherein the beanbag exterior exhibits an image identifying a sports personality; a first compartment located within the beanbag exterior, and configured to hold first amount of fill material; a second compartment located within the beanbag exterior and above the first compartment, and wherein the second compartment is configured to hold a second amount of fill material; and where the first amount of fill material in the first compartment and the second amount of fill material in the second compartment are configured to generally maintain the beanbag in an upright position.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a front view of one embodiment of the disclosed sports beanbag;

FIG. 2 is a top view of the sports beanbag from FIG. 1;

FIG. 3 is a rear view of the sports beanbag from FIG. 1;

FIG. 4 is a front view of a baseball cap embodiment of the disclosed sports beanbag; and

FIG. 5 is a front view of a basketball jersey embodiment of the disclosed sports beanbag.

### DETAILED DESCRIPTION

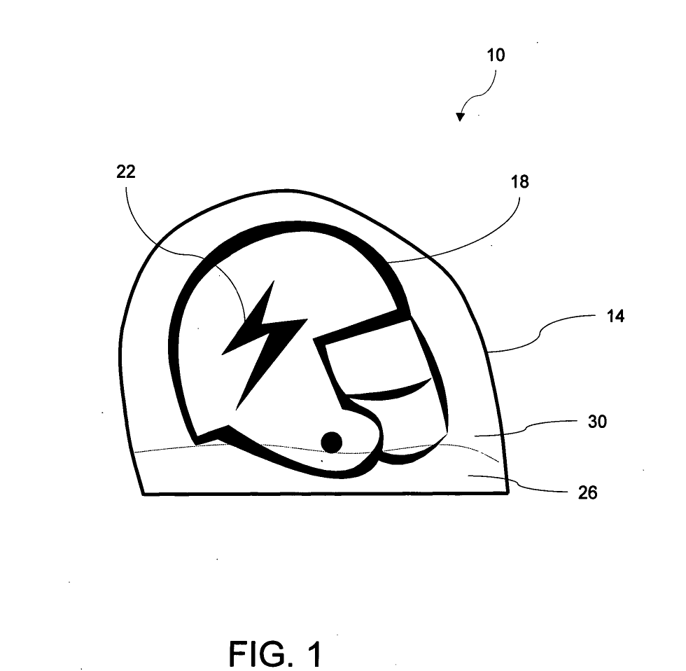

FIG. 1 is a front view of one embodiment of a sports beanbag 10. The beanbag exterior 14 may be made from any material capable of holding the fill material of the beanbag 10, such material may be, but not limited to: cotton, cotton-polyester blend, polyester, plastic, vinyl, rubber and wool. On the exterior 14, there will be an image identifying a sports team, such as a sports team logo, insignia or emblem. In the embodiment shown in FIG. 1, a football helmet image 18 with a team emblem 22 is shown on the beanbag 10. It will be obvious to one of ordinary skill in the art, that the football helmet image 18 will have colors matching the colors of the actual team helmet. The beanbag may comprise a first compartment 26 and a second compartment 30. In the first compartment, a relatively heavy fill material may be used, such as, but not limited to: sand, small pellets, shot, plastic pellets, polystyrene granules, fiberfill or pellets, and hypo-allergenic fiber mix. The fill material in the second compartment 30 may be a lighter fill material than that in the first compartment 26, such material may be, but not limited to: polystyrene granules or pellets, hypo-allergenic fiber mix, plastic pellets, and fiberfill.

The fill material may be apportioned such that the sports beanbag 10 will “stand up”, that is, when one sets the sports beanbag 10 down, it will remain in an upright position, due to the heavier weight of the fill material in the first compartment 26. Also, the exterior 14 may be made of a non-skid material, such as to allow the sports beanbag 10 to be used as a doorstop, in addition to, or instead of a paperweight. Additionally, due to the pliable nature of the sports beanbag 10, it may also be used as a cushion or pillow, or a stress relieving device when squeezed.

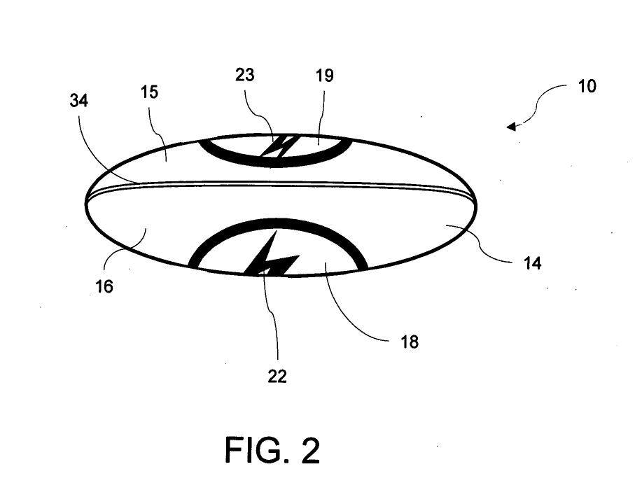

FIG. 2 shows a top view of the sports beanbag 10. A seam 34 may be used to couple two exteriors surfaces 15, 16 to form one exterior 14. In another embodiment, the exterior 14 may not have a visible seam.

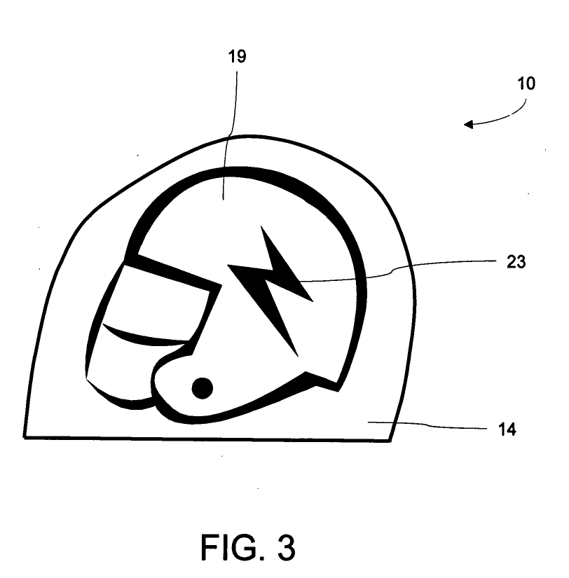

FIG. 3 shows a rear view of the sports beanbag 10. In this view, it is clearly seen that the football helmet image 19 with a team emblem 23 are mirror images of the helmet image 18 and emblem 22, this allows for a sports beanbag 10 that has a generally football helmet profile shape, that is a non-symmetric shape such that when one views it from the front, the helmet shape faces to the right, and when one views it from the rear, the helmet shape faces to the left. However, the beanbag 10 may be symmetric, with a helmet image 18 and emblem 22, on one side, and a mirror helmet image 19 and mirror image emblem 23 on the other, or with the helmet image 18 and emblem 22 on both sides. Additionally, in a non-symmetric configuration, both the front and read of the sports beanbag 10 may have a football helmet image 18 and emblem 22.

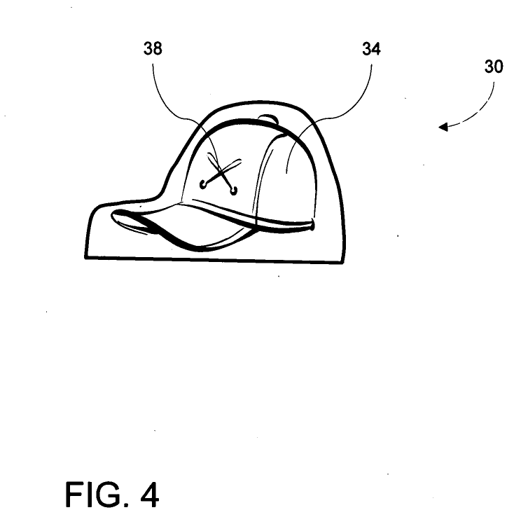

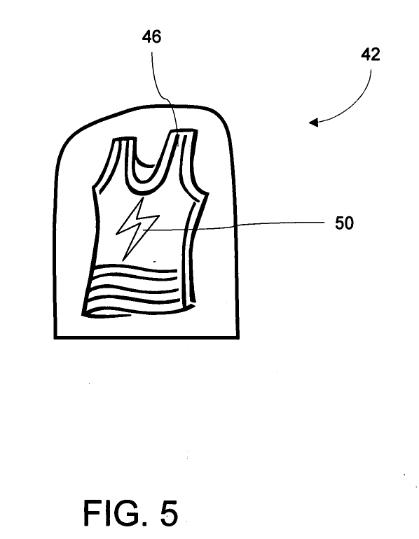

Although the embodiments described above show a sports beanbag 10 with a football helmet shape and football helmet image 18 on the beanbag, it should be obvious to one of ordinary skill in the art to modify the beanbag 10 such that instead of a football helmet image on the beanbag 10, other images may be used, such as, but not limited to: baseball cap, basketball jersey, hockey jersey, any sports equipment or apparel. For instance, FIG. 4 shows another embodiment of the sports beanbag 30, wherein the beanbag has a generally baseball cap shape, and a baseball cap image 34 is on the beanbag 30, and a baseball team emblem 38 is on the baseball cap image 34. FIG. 5 shows another embodiment of the sports beanbag 42, wherein the beanbag has a generally basketball jersey shape, and a basketball jersey image 46 is on the beanbag 42, and a basketball team emblem 50 is on the jersey image 46. In addition, the image on the beanbag may be of a sports personality, such as an athlete or a mascot. Additionally, professional sports team emblems 18 may be represented on the beanbag 10, as well as college team emblems, high school team emblems, pee wee league emblems, or any other sports league emblem or sporting organization emblem.

The disclosed sports beanbag 10 may be sized according to its use as a paperweight or a doorstop. If the beanbag 10 is to be used mainly as a paperweight, the beanbag may be sized to be about 2 to 4 inches tall. If the beanbag 10 is to be used mainly as a doorstop, the beanbag may be sized to be about 6 to 12 inches tall. Of course, one of ordinary skill in the art may adjust the beanbag sizes based upon customer wishes or uses.

The disclosed sports beanbag provides a pliable apparatus which may be used as a paperweight, doorstop, and cushion, in addition to allowing the user to express his or her support for a particular sports team or sports figure. Since the beanbag is pliable, it may also be squeezed by hand in order to provide stress relief to the user. The beanbag is able to stand upright due to the distribution of the fill material in the compartments of the beanbag.

It should also be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims

What is claimed is:

1. A sports beanbag comprising:
a beanbag exterior, wherein the beanbag exterior exhibits an image identifying a sports team;
a first compartment located within the beanbag exterior, and configured to hold a first amount of fill material;
a second compartment located within the beanbag exterior and above the first compartment, and wherein the second compartment is configured to hold a second amount of fill material; and
wherein first amount of fill material in the first compartment and the second amount of fill material in the second compartment are configured to generally maintain the beanbag in an upright position.

2. The sports beanbag of claim 1, wherein the beanbag is shaped generally like a football helmet.

3. The sports beanbag of claim 1, wherein the image is a football helmet with a team logo on the football helmet.

4. The sports beanbag of claim 1, wherein the beanbag is sized to for paperweight use.

5. The sports beanbag of claim 1, wherein the beanbag is sized for doorstop use.

6. The sports beanbag of claim 1, wherein the beanbag is shaped generally like a baseball cap.

7. The sports beanbag of claim 6, wherein the image is a baseball cap with a team logo on the baseball cap.

8. The sports beanbag of claim 1, wherein the beanbag is shaped generally like a basketball jersey.

9. The sports beanbag of claim 8, wherein the image is a basketball jersey with a team log on the basketball jersey.

10. A sports beanbag comprising:
a beanbag exterior, wherein the beanbag exterior exhibits an image identifying a sports personality;
a first compartment located within the beanbag exterior, and configured to hold a first amount of fill material;
a second compartment located within the beanbag exterior and above the first compartment, and wherein the second compartment is configured to hold a second amount of fill material;
wherein the first amount of fill material in the first compartment and the second amount of fill material in the second compartment are configured to generally maintain the beanbag in an upright position.

11. The sports beanbag of claim 10, wherein the beanbag has a generally human shape.
